(19) United States
(12) Patent Application Publication
(10) Pub. No.: US 2009/0261042 A1
(43) Pub. Date: Oct. 22, 2009

(54) METHOD FOR ADSORPTION OF FLUID CONTAMINANTS AND REGENERATION OF THE ADSORBENT

(76) Inventors: Raphael Semiat, Haifa (IL); Grigori Zelmanov, Holon (IL); Altai Bach, Haifa (IL)

Correspondence Address: BROWDY AND NEIMARK, P.L.L.C.;624 NINTH STREET, NW, SUITE 300, WASHINGTON, DC, 20001-5303, US

(21) Appl. No.: 12/306,926

(22) PCT Filed: Jun. 25, 2007
(86) PCT No.: PCT/IL07/00765

§ 371 Date: Jun. 15, 2009

Related U.S. Application Data
(60) Provisional application No. 60/816,643, filed on Jun. 27, 2006.

(51) Int. Cl. B01J 49/00; B01J 39/24; B01J 38/48

(52) U.S. Cl. 210/673; 502/22; 210/660; 977/903; 977/773

(57) ABSTRACT

The invention provides methods for treating a fluid, particularly water, contaminated with organic compounds, organisms, toxic substances, hazardous substances, ammonia, or mixtures thereof, by adsorption with an adsorbent material and regeneration of the purified adsorbent material. The contaminants may be first adsorbed onto the adsorbent material, which is then regenerated by treatment with nanoparticles of at least one transition metal oxide catalyst and at least one oxidant; or the contaminants are adsorbed onto particles of the adsorbent material loaded with at least one transition metal oxide, which is then regenerated by treatment with an oxidant; or the contaminated fluid is treated with an oxidant first and then with particles of the adsorbent material loaded with at least one transition metal oxide. The adsorbed contaminants are converted into environmentally compatible products.

### FIELD OF THE INVENTION

The present invention relates to an adsorption method for treating a fluid containing undesired contaminants and to a catalytic process for the regeneration of the adsorbent material by using oxides of transition metals in form of nanocatalyst or colloids. and an oxidant. The method is suitable for the elimination of hazardous contaminants, particularly organic materials, from drinking water, surface water, groundwater, industrial wastewaters, and for chemical regeneration of adsorbents such as activated carbon, activated alumina, activated TiO₂, mineral clay, zeolite, ion exchangers and mixtures thereof.

### BACKGROUND OF THE INVENTION

Organic pollutants, organisms, toxic substances, some metals and mixtures thereof are often present in drinking water, groundwater, and industrial wastewaters.

Traditional water treatment processes such as adsorption, coagulation, flocculation and membrane technologies achieve removal of the undesired contaminants by merely transferring the pollutants from one phase to another, producing concentrated sludge and leaving the problems of disposing the transferred pollutants and regenerating removed adsorbent.

Organic and biological pollutants may be treated by suitable chemical oxidation processes. These processes are usually slow, inefficient and somewhat limited in terms of the non-biodegradability and toxicity of some contaminants to microorganisms (Toledo et al., 2003).

Water treatment processes based on the chemical oxidation of organic compounds by Advanced Oxidation Processes (AOPs), which are useful for purifying surface water and groundwater and for cleaning industrial wastewater, have been reported recently (Sigman et al., 1997; Yeber et al., 2000; Perez et al., 2002). Several of these works have focused on using these systems as a pre-treatment for biological systems when the dissolved organic matter is toxic, inhibitory or recalcitrant to microorganisms.

The degradation and mineralization of organic pollutants in wastewater by AOPs is based on the generation of a very reactive free hydroxyl radical (OH*). This radical is generated by the decomposition of hydrogen peroxide with ferrous iron-Fe²⁺. The hydroxyl radical is highly reactive, non-selective and may be used to degrade a wide range of organic pollutants. It reacts with most organic compounds by adding to a double bond or by abstracting hydrogen atoms from organic molecules (Safarzadeh-Amiri et al., 1996, 1997). The resulting organic radicals then react with oxygen and leads to the complete mineralization to form CO₂, H₂O and mineral acids (Oliveros et al., 1997).

Fenton and Fenton-like systems (Fe⁺²/Fe⁺³/H₂O₂) are often used for industrial water treatment (Neyens and Baeyens, 2003). The mechanism for producing free hydroxyl radicals in Fenton (Fe⁺²/H₂O₂) and Fenton-like processes (Fe⁺³/H₂O₂) is very complex and thought to occur in the following stages (Lin and Gurol, 1998; De Heredia et al., 2001; Safarzadeh-Amiri et al., 1996; Neyens and Baeyens, 2003):

Fe³⁺+H₂O₂→Fe—OOH²⁺+H⁺ (1)

Fe—OOH²⁺→Fe²⁺+HO₂⁻ (2)

Fe²⁺+H₂O₂→Fe³⁺+OH⁻+OH⁻ (3)

Fe²⁺+OH⁻→Fe³⁺+OH⁻ (4)

H₂O₂+OH⁻→HO₂⁻+H₂O (5)

2Fe²⁺+H₂O₂+2H⁺→2Fe³⁺+2H₂O (6)

The first three equations are responsible for the continuous production of the active radical (Lin and Gurol, 1998), the next two for the decay of this radical, and the final one for reducing the peroxide concentration.

Post-treatment requires the elimination of the Fenton reagents as colloidal precipitates and the separation of the colloidal precipitates by additional processes such as coagulation, sedimentation and filtration.

Inorganic ions (HCO₃, PO₄/HPO₄/H₂PO₄, Cl, SO₄, Ca, Na, Mg, etc.) are often present in wastewater and play a significant role in the reaction rate of the Fenton process (Andreozzi et al., 1999; De Laat et al., 2004; Maciel et al., 2004). De Laat et al. (2004) investigated the effects of chloride, perchlorate, sulfate and nitrate ions on the decomposition rates of H₂O₂ and the oxidation of organic compounds by Fe⁺²/H₂O₂ and Fe⁺³/H₂O₂ and showed that the efficiency of the Fe⁺³/H₂O₂ oxidation process can be reduced in the presence of chloride and sulfate ions. These inhibitory effects were attributed to a decrease in the rate of generation of hydroxyl radicals and the formation of Cl₂*⁻ and SO₄* radicals that are less reactive than the OH* radical. Some inorganic ions such as HCO₃ and PO₄, can also reduce the efficiency of the oxidation process through the formation of radicals less reactive than OH*, HCO₃* and PO₄ (Andreozzi et al., 1999).

Lu et al. (1997) investigated the effects of inorganic ions on the oxidation of dichlorvos (dimethyl 2,2-dichloroethenyl phosphate) insecticide with Fenton's reagent. Anions suppress the decomposition of dichlorvos in the following sequence: H₂PO₄⁻>>Cl>NO₃≈ClO₄. The main reason for the suppression of phosphate ions is that these ions produce a complex reaction together with ferrous and ferric ions, causing loss of catalytic activity.

Photochemical degradation and mineralization of phenol and the effect of the presence of radical scavengers (PO₄, SO₄ and Cl ions) were investigated by Bali et al. (2003). The highest negative effect was observed with a solution containing PO₄ ions.

As follows from our unpublished results, treatment of an aqueous solution having an initial phenol concentration of 1100 ppm with 80 ppm Fe³⁺ nanocatalyst and 0.48% hydrogen peroxide, in the absence of phosphorous ions dissolved in water, resulted in a phenol concentration of 0.35 ppm in 5 min. However, when the phosphorous ion concentration exceeded 75 ppm, the other extreme condition here, the phenol concentration remained unchanged throughout the experiment. Similar to the phosphorous ions, also HCO₃ ion concentration had a significant influence on phenol degradation rate and lag time period. Thus, for a nanocatalyst concentration of 80 ppm, the phenol concentration dropped from 1100 to 0.35 ppm after 5 min in the absence of HCO₃ ions, and to 135 ppm after 5 min with a 100 ppm HCO₃ ion concentration. For an HCO₃ ion concentration of 150 ppm, no phenol oxidation reaction was observed.

From these data it follows that Fenton, photo-Fenton and Fenton-like processes are not efficient in the presence of inorganic ions-radical scavengers, such as HCO₃, PO₄/HPO₄/H₂PO₄, Cl, SO₄, Ca, Na, Mg, etc. This problem can be solved by increasing the concentration of the catalyst or concentrations of hydrogen peroxide. Thus, by increasing Fe³⁺ nanocatalyst concentration to 200 ppm, phenol is efficiently destroyed and its concentration decreased from 1100 to 1.9 ppm in 5 min of reaction. Also increase of the hydrogen peroxide concentration leads to start of the reaction. Thus, for initial concentration of 1100 ppm phenol, 100 ppm Fe³⁺ nanocatalyst, concentration of phosphorous ions higher than 75 ppm and 0.48% hydrogen peroxide, no phenol oxidation reaction was observed. By raising hydrogen peroxide concentration to 0.96%, phenol is effectively destroyed and its concentration decreased from 1100 ppm to 0.85 ppm.

It should be noted that increasing Fe³⁺ nanocatalyst and/or hydrogen peroxide makes this treatment still cost ineffective for water purification.

Water treatment based on the adsorption of contaminants from fluids by adsorbent material is useful for purification of drinking water, groundwater and for cleaning of industrial wastewater containing also radical scavengers. In this case, the adsorbent adsorbs from the solution only molecules of organic matter and the inorganic ions-radical scavengers (such as HCO₃, PO₄/HPO₄/H₂PO₄, Cl, SO₄, Ca, Na, Mg etc) remain in the solution. The spent activated carbon does not contain inorganic ions-radical scavengers and they therefore do not influence its regeneration.

Adsorbents are chosen from materials with porous structure and large internal surface area such as activated carbon, e.g., granular or powder activated carbon, activated alumina, mineral clay, zeolite, ion exchanger, or mixtures thereof. Using adsorption processes for water treatment requires recovery of the adsorbent material. Application of an adsorbent depends on its cost and on the adsorptive capacity after some adsorption-regeneration cycles.

Activated carbons are among the most effective adsorbents, but are rather expensive to use. Some methods have been used for the treatment and regeneration of spent activated carbon. These methods can be classified in three large groups: thermal, biological and chemical regeneration Thermal regeneration, usually carried out at 700-1100° C., demands high energy, leads to loss of considerable amounts of activated carbon (5-15%) by attrition, burn off and washout in every adsorption-regeneration cycle, and frequently leads to loss of activated carbon surface area by destruction of micropores. Biological treatment is not efficient and has some limitations concerning the non-biodegradability and the toxicity of some contaminants to microorganisms.

Chemical regeneration may be carried out by desorption of adsorbents by specific solvents or by its destruction by using oxidation process. A treatment based on the chemical oxidation of organic compounds by advanced oxidation processes (AOPs) is useful for regeneration of spent activated carbon. The degradation and mineralization of organic pollutants adsorbed by activated carbon by AOPs is based on the generation of a very reactive free hydroxyl radical (OH*). This radical is generated by the decomposition of hydrogen peroxide with ferrous iron-Fe²⁺ (Neyens and Baeyns, 2003) or by photocatalysis process. The free hydroxyl radical is highly reactive, non-selective and may be used to degrade a wide range of organic pollutants.

The degradation rate of organic pollutants with Fenton reagents or by photo catalysis strongly depends on irradiation with UV light, and increases with increased UV irradiation intensity (Safarzadeh-Amiri et al., 1996). Using the UV light system results in a significant increase in the cost of industrial water treatment.

Adsorption is widely used for treatment of fluids containing undesired contaminants (see U.S. Pat. Nos. 5,198,001, 4,624,789, 4,544,488). Ultraviolet enhanced chemical oxidation processes have been used to treat contaminated fluids (see U.S. Pat. Nos. 4,735,728; 5,215,592, 4,780,287, 5,045,288, 5,120,450, 5,043,080). The principles of regeneration of activated carbon that include introducing ultraviolet radiation are described in U.S. Pat. No. 4,861,484 and WO 95/21794. The principles of regeneration of activated carbon, including introducing ultraviolet radiation and nano-TiO₂ as photocatalyst, are described in CN 1554478.

### SUMMARY OF THE INVENTION

The present invention provides efficient and cost effective methods for cleaning of fluids containing organic and some inorganic contaminants, especially wastewaters from industrial processes, contaminated ground waters and municipal water, by adsorption of the contaminants from the water solutions, followed by low temperature catalytic cleaning of the adsorbent using oxides of transition elements in form of nanocatalyst and oxidants.

The methods provided by the invention are particularly useful for treating a fluid, particularly water, contaminated with organic compounds, organisms, toxic substances, hazardous substances, ammonia, or mixtures thereof, by adsorption of the contaminants with an adsorbent material and regeneration of the contaminated adsorbent material in purified form. In one embodiment, the contaminants are first adsorbed onto the adsorbent material, which is then regenerated by treatment with nanoparticles of at least one transition metal oxide catalyst and at least one oxidant. In another embodiment, the fluid contaminants are adsorbed onto particles of the adsorbent material loaded with at least one transition metal oxide, which is then regenerated by treatment with at least one oxidant. In a further embodiment, the contaminated fluid is treated with an oxidant first and then with particles of the adsorbent material loaded with at least one transition metal oxide. The adsorbed contaminants are converted into environmentally compatible products.

The invention thus relates, in one embodiment, to a method for treating a fluid containing contaminants selected from organic compounds, organisms, toxic substances, hazardous substances, ammonia, or mixtures thereof, with regeneration of the purified adsorbent material, said method comprising:

a) adsorption of said contaminants onto particles of an adsorbent material selected from activated carbon, activated alumina, activated TiO₂, mineral clay, zeolite, an ion exchanger, or mixtures thereof; and

b) regeneration of the adsorbent material by contact with nanoparticles of at least one transition metal oxide catalyst and at least one oxidant, whereby the adsorbed contaminants are converted into environmentally compatible products.

In another embodiment, the present invention relates to a method for treating a fluid containing contaminants selected from organic compounds, organisms, toxic substances, hazardous substances, ammonia, or mixtures thereof, with regeneration of the purified adsorbent material, said method comprising:

a) adsorption of said contaminants onto particles of an adsorbent material selected from activated carbon, activated alumina, activated TiO₂, mineral clay, zeolite, an ion exchanger, or mixtures thereof, loaded with nanoparticles of at least one transition metal oxide catalyst; and

b) regeneration of the adsorbent material by contact with at least one oxidant, whereby the adsorbed contaminants are converted into environmentally compatible products.

In a further embodiment, the present invention relates to a method for treating a fluid containing contaminants selected from organic compounds, organisms, toxic substances, hazardous substances, ammonia, or mixtures thereof, with regeneration of the purified adsorbent material, said method comprising:

a) loading an adsorbent material selected from activated carbon, activated alumina, activated TiO₂, mineral clay, zeolite, an ion exchanger, or mixtures thereof, with nanoparticles of at least one transition metal oxide catalyst; and

b) treating the contaminated fluid with at least one oxidant; and

c) mixing with, or passing through, the contaminated fluid containing the oxidant through the loaded adsorbent material of a), whereby the adsorbed contaminants are converted into environmentally compatible products, thus obtaining purified adsorbent material.

In a further aspect, the invention relates to a method of regeneration of spent adsorbent containing adsorbed contaminants selected from organic compounds, organisms, toxic substances, hazardous substances, ammonia, or mixtures thereof, by mixing the spent adsorbent with a solution comprising at least one oxide of transition metal nanocatalyst and at least one oxidant, to yield an adsorbent substantially free from adsorbed contaminants.

### DETAILED DESCRIPTION OF THE INVENTION

The method of the present invention can be defined as an adsorption/catalytic regeneration process for treating a fluid containing undesired contaminants selected from the group consisting of organic compounds, organisms, toxic substances, hazardous substances, ammonia and mixtures thereof, wherein the contaminants are adsorbed on an adsorbent material and the adsorbent material is treated with nano-particles of at least one transition metal oxide catalyst ( herein also called “at least one oxide of transition metal nanocatalyst”) and an oxidant, whereby the adsorbed contaminants are degraded into environmentally compatible reaction products comprising water and carbon dioxide.

In one embodiment, the contaminated fluid is treated with the adsorbent and the contaminated adsorbent is treated with nanoparticles of at least one transition metal oxide catalyst and an oxidant. In another embodiment, the contaminated fluid is treated with the adsorbent loaded with nanoparticles of at least one transition metal oxide catalyst and the contaminated adsorbent is treated with an oxidant. In both embodiments, the fluid is purified from the contaminants and the adsorbent material is regenerated for further use. In one preferred embodiment, the two steps occur concomitantly, without the need to separate the adsorbent from the fluid for the regeneration treatment.

Thus, in the method of the invention, the adsorbent material may be a virgin or regenerated adsorbent material.

The adsorbent used in the process of the invention is selected from the group consisting of activated carbon, activated alumina, activated TiO₂, mineral clay, zeolite, an ion exchanger, and mixtures thereof.

The oxide of transition metal for use as catalyst in the present invention may be an iron oxide such as Fe₂O₃, FeOOH, FeFe₂O₃, Mn Fe₂O₃, Co Fe₂O₃, Cu Fe₂O₃, or TiO₂ or mixtures thereof, in the form of nanoparticles as known in the art.

The oxidant for use in the present invention is selected from the group consisting of oxygen, ozone, hydrogen peroxide, hydroxyl radicals, inorganic ions radicals, oxone (2KHSO₅·KHSO₄·K₂SO₄) and mixtures thereof.

In one preferred embodiment, the adsorbent material is activated carbon that may be granular or powder activated carbon. The activated carbon will gradually become saturated, due to the concentration of contaminants on the surface of the adsorbent. Since it is a valuable commodity, it is important to recycle the spent carbon. The treatment with the transition metal oxide nanocatalyst and the oxidant according to the method of the present invention allows efficient reactivation of the spent carbon and further use of the reactivated carbon in the method. As shown in the Examples hereinafter, spent carbon could be regenerated at least 5 times by treatment with iron (III) oxide and hydrogen peroxide.

The method of the present invention is unique in its ability to degrade large quantities and high concentrations of organic pollutants in a fluid into carbon dioxide, water and other non toxic environmentally compatible products. No chemical pretreatment whatsoever of the fluid containing organic contaminants to be degraded is required.

In one preferred embodiment, the fluid to be treated is liquid, more preferably water. Thus, the present invention may be employed in some different ways as an environmentally compatible process for purifying potable water, groundwater, industrial, agricultural and municipal wastewater.

The present invention thus provides a method for purification of water, comprising the following steps:

a) purifying the water by adsorption of water contaminants selected from the group consisting of organic compounds, organisms, toxic substances, hazardous substances, ammonia, and mixtures thereof, on an adsorbent material selected from the group consisting of activated carbon, activated alumina, activated TiO₂, mineral clay, zeolite, an ion exchanger, and mixtures thereof; and

b) mixing with, or passing through, the adsorbent material containing the contaminants a solution comprising nanoparticles of at least one transition metal oxide such as Fe₂O₃, FeOOH, FeFe₂O₃, MnFe₂O₃, CoFe₂O₃, CuFe₂O₃, TiO₂, or mixtures thereof, and an oxidant selected from the group consisting of oxygen, ozone, hydrogen peroxide, hydroxyl radicals, inorganic ions radicals, oxone and mixtures thereof, to yield a purified adsorbent material and environmentally compatible reaction products.

In one embodiment, the method for water purification comprises the steps:

a) loading an adsorbent material selected from the group consisting of activated carbon, activated alumina, activated TiO₂, mineral clay, zeolite, an ion exchanger, and mixtures thereof, with at least one transition metal oxide nano-catalyst such as Fe₂O₃, FeOOH, FeFe₂O₃, MnFe₂O₃, CoFe₂O₃, or CuFe₂O₃, TiO₂, or mixtures thereof;

b) obtaining purified water by adsorption of its contaminants selected from the group consisting of organic compounds, organisms, toxic substances, hazardous substances, ammonia and mixtures thereof, on said adsorbent material loaded with said at least one transition metal oxide nanocatalyst; and

c) mixing with, or passing through, the adsorbent material loaded with the at least one transition metal oxide nanocatalyst and containing the adsorbed contaminants, a solution comprising an oxidant selected from the group consisting of oxygen, ozone, hydrogen peroxide, hydroxyl radicals, inorganic ions radicals, oxone and mixtures thereof, to yield a purified adsorbent material and environmentally compatible reaction products.

In another embodiment, the method for water purification comprises:

a) loading an adsorbent material selected from the group consisting of activated carbon, activated alumina, activated TiO₂, mineral clay, zeolite, an ion exchanger, and mixtures thereof, with at least one transition metal oxide nano-catalyst such as Fe₂O₃, FeOOH, FeFe₂O₃, MnFe₂O₃, CoFe₂O₃, or CuFe₂O₃, TiO₂, or mixtures thereof;

b) adding to polluted water an oxidant selected from the group consisting of oxygen, ozone, hydrogen peroxide, hydroxyl radicals, inorganic ions radicals, oxone and mixtures thereof; and

c) mixing and/or passing the polluted water containing the oxidant through said adsorbent material loaded with the at least one transition metal oxide nano-catalyst or mixtures thereof, to yield purified water, purified adsorbent material and environmentally compatible reaction products.

The environmentally compatible reaction products comprise at least CO₂ and water and may comprise other non-toxic environmentally compatible products such as mineral acids. The reaction products evolve partially in a gaseous state and, in part, become dissolved in the fluid.

The present invention further provides a method of regeneration of spent adsorbent containing adsorbed contaminants selected from the group consisting of organic compounds, organisms, toxic substances, hazardous substances, ammonia and mixtures thereof, by mixing the spent adsorbent with a solution comprising at least one oxide of transition metal oxide nanocatalyst and an oxidant, to yield an adsorbent substantially free from adsorbed contaminants.

The adsorbent material may be activated carbon, activated alumina, activated titanium dioxide, mineral clay, zeolite, ion exchangers or mixtures thereof. The transition metal oxide nano-catalyst may be an iron oxide such as Fe₂O₃, FeOOH, FeFe₂O₃, MnFe₂O₃, CoFe₂O₃, or CuFe₂O₃, or TiO₂, or mixtures thereof, and the oxidant may be oxygen, ozone, hydrogen peroxide, hydroxyl radicals, inorganic ions radicals, oxone or mixtures thereof. In one embodiment, the adsorbent material is activated carbon, the transition metal nanocatalyst is iron (III) oxide, and the oxidant is hydrogen peroxide.

The present invention provides also an environmentally compatible process for eliminating hazardous organic materials contained in sludge or other solid wastes, or mixed with or adsorbed by soil. This process comprises the steps of: extracting the sludge, soil waste, or soil with an organic solvent or with water containing one or more detergents to produce a fluid containing the hazardous organic materials and thereafter purifying the contaminated fluid according to the method of the present invention.

The present invention can be used in a non-exhaustive list of applications and is of economic significance for these applications.

Contamination of water with organic pollutants presents a significant ecological problem. Traditional water treatments include some processes such as: adsorption, coagulation, flocculation and membrane technologies that achieve the removal of the pollutants by separation. These non-destructive technologies only transfer the pollutants from one phase to another and produce toxic sludge, leaving a problem of disposal of the transferred materials. Today, the primary methods of disposing of hazardous waste are through landfill and incineration. Intermediate treatment steps used extensively in the clean up of drinking water and wastewater are air stripping and treatment via carbon adsorption. Thus, air stripping converts a liquid contamination problem into an air pollution problem and carbon adsorption produces a hazardous solid that cannot be directly land filled. Therefore, establishment of destructive technologies that lead to harmless products are highly required. In addition, technologies that destroy hazardous materials must also accomplish this task at an economically competitive cost. The present invention accomplishes this task by offering a means to destroy hazardous organics at a cost significantly below the state-of-the-art technology.

One of the most widely used technologies in the treatment of drinking water, wastewaters, contaminated ground waters and municipal water is adsorption by granular activated carbon (GAC). While GAC is very effective in removing hazardous organics from liquid and gas streams, the GAC eventually becomes saturated with the hazardous material and must be treated itself. Today, contaminated GAC is either land filled or regenerated via thermal process. This regeneration or landfill is one of the most costly steps in the use of GAC. Thermal regeneration is very capital intensive and requires a significant investment in capital equipment, operation and maintenance. The GAC must be physically removed from its tower container and transported to a regeneration facility. In many cases the regeneration furnaces are located off site requiring transportation and associated costs. During the thermal regeneration process up to 10% of the GAC is destroyed. Finally, additional costs are incurred in hauling the GAC back to the treatment location and reinserting it into the tower container.

The present invention enables the regeneration of spent adsorbent materials with porous structure and large internal surface area such as activated carbon, granular activated carbon, and powder activated carbon, activated alumina, mineral clay, zeolite, ion exchanger and mixtures thereof in-situ, and eliminates the need for thermal regeneration. With the technology of the present invention, the GAC may be regenerated without removing it from the container. The contaminants are destroyed in the same container and, therefore, the capital cost for furnaces and related operations, the maintenance cost and the necessity to landfill are eliminated.

A number of industries produce hazardous organics as by-products. Today, these hazardous materials are either land filled or incinerated. The ability to landfill hazardous materials is limited. Incineration is very capital intensive and requires a significant investment in capital equipment, operation and maintenance. Landfill and incineration involve considerable transportation costs.

The present invention enables destruction of the adsorbed hazardous organic materials directly within the adsorbent container and thus eliminates the need for landfill or incineration.

The invention will now be illustrated by the following examples describing experiments performed in the laboratory. It should be noted that the equipment and experimental design is solely in laboratory scale, nevertheless it is clear that these parameters can be expanded to meet industrial and commercial scale operation. In addition, it should be expressly understood that while in the examples a limited number of different organic materials are degraded using only the preferred transition element oxide catalyst and hydrogen peroxide, these empirical details do not either restrict or limit the present invention in any way. To the contrary, these empirical experiments are merely representative of the number, variety, and diversity of organic materials and reactive conditions, which can be advantageously employed using the present invention.

### EXAMPLES

### Experimental Design and General Protocol

Iron chloride hexahydrate, FeCl₃×6H₂O (analytical grade; Merck KGaA, Germany), 30% hydrogen peroxide (analytical grade; Panreac Quimica SA, Spain), phenol (analytical grade; Fluka), chemically pure ethylene glycol (Bio-Lab Ltd., Israel) and activated carbon (Sigma-Aldrich Laborchemikalien GmbH, Germany) were used as received.

The specific surface area of activated carbon was measured by BET method using N₂ adsorption-desorption at 77°K with Flowsorb 2300 (Micromeritics, USA). The pH was determined using a Consort P-901 electrochemical analyzer. Total organic carbon (TOC) and phenol content analyses were made using a TOC-5000A Shimadzu analyzer and a Hach DR/2010 data logging spectrophotometer for estimation of phenol by the 4-aminoantipyrine method. Iron and iron ferrous concentrations were determined in a data logging Hach DR/2010 spectrophotometer by using FerroVer and the 1,10-phenanthroline method.

The starting material used for preparing the catalyst in form of nano-particles of iron (III) oxide was iron chloride hexahydrate, FeCl₃×6H₂O (analytical grade; Merck). Hydrolysis was used to prepare a 10% sol of iron nanocatalysts. A series of iron (III) oxide nanocatalysts was then prepared by diluting the initial solution. Typical organic contaminants such as ethylene glycol and phenol were chosen for this study as simulating pollutants. Ethylene glycol is used in large quantities as a car cooling fluid or as an airplane and runway deicer. Large quantities of ethylene glycol have created environmental hazards leading to the serious pollution of drinking water. Several types of industrial wastes contain phenols. They are very harmful and highly toxic towards microorganisms. Many phenol compounds are used as solvents or reagents in industrial processes and are therefore very common contaminants in industrial wastewater and contaminated drinking water sources.

A series of experiments were conducted to investigate the adsorption-regeneration properties of activated carbon. All these experiments were carried out at room temperature without irradiation with UV light or any visible radiation sources in the reaction cells, which were protected from extraneous light.

The values of pH by adsorption on activated carbon were ranged from 6 to 8. After adsorption, spent activated carbon was regenerated. Catalytic systems (Fe⁺³/H₂O₂) based on iron oxide nanoparticle catalyst was used. In all these experiments, hydrogen peroxide was added for complete mineralization of organic matter into CO₂, H₂O and mineral acids.

### Example 1

Purposely contaminated activated carbon was prepared as follows: 70 g aqueous solution containing 1000 ppm of phenol was mixed with 10 g virgin activated carbon during 30 min. The concentration of phenol was reduced from 1000 ppm to 0.9 ppm and the mass of adsorbed phenol per unit mass of activated carbon was 7 mg/g. The phenol-adsorbed activated carbon was then mixed during 30 min with 25 g of water containing 60 ppm of Fe⁽⁺³⁾ oxide nanocatalyst and 0.48% of hydrogen peroxide for its regeneration.

### Example 2

The spent activated carbon regenerated in Example 1 was used to purify a second portion of polluted water: 70 g aqueous solution containing 1000 ppm phenol. The concentration of phenol was reduced in this second stage from 1000 ppm to 0.875 ppm and the mass of adsorbed phenol per unit mass of activated carbon was 7 mg/g. The regenerated activated carbon therefore demonstrated negligible difference in its adsorption activity in comparison with the previously used virgin activated carbon. The phenol-adsorbed activated carbon was then mixed during 30 min with 25 g of water containing 60 ppm of Fe⁽⁺³⁾ oxide nanocatalyst and 0.48% of hydrogen peroxide for its regeneration, as described in Example 1

### Example 3

The procedure described in Example 2 was repeated for 5 additional adsorption-regeneration cycles. The concentration of phenol was reduced in the 5^{th} cycle from 1000 ppm to 0.915 ppm and the mass of adsorbed phenol per unit mass of activated carbon was 7 mg/g. The specific surface area was 847 m²/gr for the virgin activated carbon and 833 m²/gr for regenerated activated carbon following the 5^{th} cycle of regeneration. Therefore, the regenerated activated carbon after 5 cycles of regeneration maintained all the original adsorption activity of fresh, previously unused virgin activated carbon.

### Example 4

Purposely contaminated activated carbon was prepared as follows: 25 g aqueous solution containing 6400 ppm of ethylene glycol as TOC was mixed with 10 g virgin activated carbon during 30 min. The TOC concentration was reduced from 6400 ppm to 2800 ppm and the mass of adsorbed ethylene glycol per unit mass of activated carbon was 25 mg/g. The ethylene glycol-adsorbed activated carbon was then mixed during 30 min with 25 g of water containing 4000 ppm of Fe⁽⁺³⁾ oxide nanocatalyst and 2.4% of hydrogen peroxide for its regeneration. After regeneration of the spent activated carbon loaded with ethylene glycol, the regenerated activated carbon contained 0.2 mg/g of contaminants. The specific surface area was 847 m²/gr for the virgin activated carbon and 838 m²/gr for the regenerated activated carbon.

### Example 5

The spent activated carbon regenerated in Example 4 was used to purify a second portion of polluted water: 25 g aqueous solution containing 6400 ppm of ethylene glycol was mixed with 10 g of activated carbon regenerated in Example 4. The concentration of ethylene glycol was reduced in this second stage from 6400 ppm to 2800 ppm and the mass of adsorbed ethylene glycol per unit mass of activated carbon was 25.25 mg/g. Thus, the regenerated activated carbon demonstrated negligible difference in its adsorption activity in comparison with the virgin previously unused activated carbon. The ethylene glycol-adsorbed activated carbon was then mixed during 30 min with 25 g of water containing 4000 ppm of Fe⁽⁺³⁾ oxide nanocatalyst and 2.4% of hydrogen peroxide for its regeneration, as described in Example 4. After regeneration of the spent activated carbon loaded with ethylene glycol, the regenerated activated carbon contained 0.15 mg/g of contaminants. The specific surface area for the regenerated activated carbon was 832 m²/gr.

### Example 6

The procedure described of Example 5 was repeated for additional 5 adsorption-regeneration cycles. The concentration of ethylene glycol was reduced in this 5^{th} cycle from 6400 ppm to 2850 ppm and the mass of adsorbed ethylene glycol per unit mass of activated carbon was 24.5 mg/g. The specific surface area of the activated carbon following the five adsorption-regeneration cycles was 837 m²/gr. Thus, the regenerated activated carbon after the several adsorption-regeneration cycles, maintained the adsorption activity of fresh, previously unused virgin activated carbon.

### Example 7

100 g water containing 1000 ppm of phenol was mixed with 20 g virgin activated carbon during 60 min. The concentration of phenol in the water reduced from 1000 ppm to 1.0 ppm

### Example 8

Activated carbon loaded with Fe⁽⁺³⁾ oxide nanoparticles was prepared as follows: 100 g of aqueous solution containing 80 ppm of Fe⁽⁺³⁾ oxide nanoparticles was mixed with 20 g virgin activated carbon. The concentration of Fe⁽⁺³) oxide nanoparticles was reduced from 80 ppm to lower than 1 ppm and the mass of adsorbed Fe⁽⁺³⁾ oxide nanoparticles per unit mass of activated carbon was 0.25 mg/g. Twenty gram of activated carbon loaded with Fe⁽⁺³⁾ oxide nanoparticles was then mixed during 60 min with 100 g water containing 1000 ppm of phenol. In this adsorption process, the concentration of phenol was reduced from 1000 ppm to 0.15 ppm. From this data and the results of Example 7 above, it is concluded that the adsorption efficiency of activated carbon loaded with iron oxides nanoparticles is higher than that of activated carbon without iron oxides nanoparticles.

### REFERENCES:

Andreozzi, R., Caprio, V., Insola, A., Marotta, R., 1999, Advanced oxidation process for water purification and recovery. Catalysis Today. 53, 51-59.

Bali, U., Catalkaya, E. C., and Sengul, F., 2003. Photochemical degradation and mineralization of phenol: a comparative study. Journal of Environmental Science and Health. 38A, 10, 2259-2275.

De Heredia, J. B., Torregrosa, J., Dominguez, J. R., and Peres, J. A., 2001. Kinetic model for phenolic compound oxidation by Fenton's reagent. Chemosphere. 45, 85-90.

De Laat, J., Le, G. T., Legube, B., 2004. A comparative study of the effects of chloride, sulfate and nitrate ions on the rates of decomposition of H₂O₂ and organic compounds by Fe⁽⁺²⁾/H₂O₂ and Fe⁽⁺³⁾/H₂O₂. Chemosphere. 55, 715-723.

Lin, S- S., and Gurol, M. D., 1998. Catalytic decomposition of hydrogen peroxide on iron oxide: kinetics, mechanism, and implications. Environ. Sci. Technol. 32, 1417-1423.

Lu, M. C., Chen, J. N., Chang, C. P., 1997. Effect of inorganic ions on the oxidation of dichlorvos insecticide with Fenton s reagent. Chemosphere. 35(10), 2285-2293.

Maciel, R., Sant'Anna, G., L., and Dezotti, Jr., M., 2004. Phenol removal from high salinity effluents using Fenton's reagent and photo-Fenton reactions. Chemosphere. 57, 711-719.

Neyens, E., Baeyens, J., 2003. A review of classic Fenton's peroxidation as an advanced oxidation technique. Journal of Hazardous Materials. B98, 33-50.

Oliveros, E., Legrini, O., Holb, M., Muller, T., Braun, A., 1997. Industrial wastewater treatment: large scale development of a light-enhanced Fenton reaction. Chemical Engineering and Processing. 36, 397-405

Perez, M., Torrades, F., Garcia-Hortal, J. A., Domenech, X., Peral, J., 2002. Removal of organic contaminants in paper pulp treatment effluents under Fenton and photo-Fenton conditions. Applied Catalysis. 36, 63-74.

Safarzadeh-Amiri, A., Bolton, J. R., and Cater, S. R., 1997. Ferrioxalate-mediated photodegradation of organic pollutants in contaminated water. Wat. Res. 31, 787-798.

Safarzadeh-Amiri, A., Bolton, J. R., Cater, S. R., 1996. The use of iron in advanced oxidation processes. J. Adv. Oxid. Technol. 1 (1), 18-26.

Sigman, M. E., Buchanan, A. C., Smith S. M. (1997) Application of advanced oxidation process technologies to extremely high TOC aqueous solutions. J. Adv. Oxid. Technol. 2, 415-423.

Toledo, L. S., Bemardes Silva, A. C., Augusti, R., Lago, R. M., 2003. Application of Fenton's reagent to regenerate activated carbon saturated with organochloro compounds. Chemosphere. 50,1049-1054.

Yeber, M. C., Rodriguez, J., Freer, J., Duran, N., Mansilla, H., D., 2000. Photo catalytic degradation of cellulose bleaching effluent by supported TiO₂ and ZnO. Chemosphere. 41, 1193-1197.

1. A method for treating a fluid containing contaminants selected from the group consisting of organic compounds, organisms, toxic substances, hazardous substances, ammonia, or mixtures thereof, by adsorption with an adsorbent material and regeneration of the purified adsorbent material, said method comprising:
a) adsorption of said contaminants onto particles of an adsorbent material selected from the group consisting of activated carbon, activated alumina, activated TiO₂, mineral clay, zeolite, an ion exchanger, or mixtures thereof; and
b) regeneration of the adsorbent material by contact with nanoparticles of at least one transition metal oxide catalyst and at least one oxidant, whereby the adsorbed contaminants are converted into environmentally compatible products.

2. The method according to claim 1, wherein steps a) and b) occur concomitantly.

3. A method for treating a fluid containing contaminants selected from the group consisting of organic compounds, organisms, toxic substances, hazardous substances, ammonia, or mixtures thereof, by adsorption with an adsorbent material and regeneration of the purified adsorbent material, said method comprising:
a) adsorption of said contaminants on particles of an adsorbent material selected from the group consisting of activated carbon, activated alumina, activated TiO₂, mineral clay, zeolite, an ion exchanger, or mixtures thereof, loaded with nanoparticles of at least one transition metal oxide catalyst; and
b) regeneration of the adsorbent material by contact with at least one oxidant, whereby the adsorbed contaminants are converted into environmentally compatible products.

4. A method for treating a fluid containing contaminants selected from the group consisting of organic compounds, organisms, toxic substances, hazardous substances, ammonia, or mixtures thereof, by adsorption with an adsorbent material and regeneration of the purified adsorbent material, said method comprising:
a) loading an adsorbent material selected from the group consisting of activated carbon, activated alumina, activated TiO₂, mineral clay, zeolite, an ion exchanger, or mixtures thereof, with nanoparticles of at least one transition metal oxide catalyst;
b) treating the contaminated fluid with at least one oxidant; and
c) mixing with, or passing through, the contaminated fluid containing the oxidant of b) through the loaded adsorbent material of a), whereby the adsorbed contaminants are converted into environmentally compatible products, thus obtaining purified adsorbent material.

5. The method according to claim 1, wherein the adsorbent material is virgin or regenerated activated carbon.

6. The method according to claim 3, wherein the adsorbent material is virgin or regenerated activated carbon.

7. The method according to claim 4, wherein the adsorbent material is virgin or regenerated activated carbon.

8. (canceled)

9. The method according to claim 1, wherein the transition metal oxide catalyst is an iron oxide, TiO₂, or a mixture thereof, the iron oxide is selected from the group consisting of Fe₂O₃, FeOOH, FeFe₂O₃, MnFe₂O₃, CoFe₂O₃, CuFe₂O₃, and a mixture thereof., and the oxidant is selected from the group consisting of oxygen, ozone, hydrogen peroxide, hydroxyl radicals, inorganic ions radicals, oxone, and mixtures thereof.

10. The method according to claim 3, wherein the transition metal oxide catalyst is an iron oxide, TiO₂, or a mixture thereof, the iron oxide is selected from the group consisting of Fe₂O₃, FeOOH, FeFe₂O₃, MnFe₂O₃, CoFe₂O₃, CuFe₂O₃, or a mixture thereof, and the oxidant is selected from the group consisting of oxygen, ozone, hydrogen peroxide, hydroxyl radicals, inorganic ions radicals, oxone, and mixtures thereof.

11. The method according to claim 4, wherein the transition metal oxide catalyst is an iron oxide, TiO₂, or a mixture thereof, the iron oxide is selected from the group consisting of Fe₂O₃, FeOOH, FeFe₂O₃, MnFe₂O₃, CoFe₂O₃, CuFe₂O₃, or a mixture thereof, and the oxidant is selected oxygen, ozone, hydrogen peroxide, hydroxyl radicals, inorganic ions radicals, oxone, or mixtures thereof.

12. The method according to claim 1, wherein the treated fluid is liquid and said liquid is potable water, ground water, or industrial, agricultural or municipal wastewater.

13. The method according to claim 3, wherein the treated fluid is a liquid and said liquid is potable water, ground water, or industrial, agricultural or municipal wastewater.

14. The method according to claim 4, wherein the treated fluid is a liquid and said liquid is potable water, ground water, or industrial, agricultural or municipal wastewater.

15. The method according to claim 1 for purification of water by adsorption with an adsorbent material and concomitant regeneration of the purified adsorbent material, comprising the following steps:
a) purifying the water by adsorption of water contaminants selected from the group consisting of organic compounds, organisms, toxic substances, hazardous substances, ammonia, and of mixtures thereof, on an adsorbent material selected from the group consisting of activated carbon, activated alumina, activated TiO₂, mineral clay, zeolite, an ion exchanger, or mixtures thereof; and
b) mixing with, or passing through, the adsorbent material containing the contaminants a solution comprising nanoparticles of at least one transition metal oxide selected from the group consisting of Fe₂O₃, FeOOH, FeFe₂O₃, MnFe₂O₃, CoFe₂O₃, CuFe₂O₃, TiO₂, and of mixtures thereof, and at least one oxidant selected from the group consisting of oxygen, ozone, hydrogen peroxide, hydroxyl radicals, inorganic ions radicals, oxone, and mixtures thereof, to yield a purified adsorbent material and environmentally compatible reaction products.

16. The method according to claim 4 for purification of water by adsorption with an adsorbent material and concomitant regeneration of the purified adsorbent material, comprising the following steps:
a) loading an adsorbent material selected from the group consisting of activated carbon, activated alumina, activated TiO₂, mineral clay, zeolite, an ion exchanger, and mixtures thereof, with at least one transition metal oxide nanocatalyst selected from the group consisting of Fe₂O₃, FeOOH, FeFe₂O₃, MnFe₂O₃, CoFe₂O₃, CuFe₂O₃, TiO₂, and mixtures thereof;
b) purifying the water by adsorption of water contaminants selected from the group consisting of organic compounds, organisms, toxic substances, hazardous substances, ammonia, and mixtures thereof, on said loaded adsorbent material of a); and c) mixing with, or passing through, the loaded adsorbent material containing the adsorbed contaminants produced in step b), a solution comprising at least one oxidant selected from the group consisting of oxygen, ozone, hydrogen peroxide, hydroxyl radicals, inorganic ions radicals, oxone, and mixtures thereof, to yield a purified adsorbent material and environmentally compatible reaction products.

17. The method according to claim 3 for purification of water by adsorption with an adsorbent material and concomitant regeneration of the purified adsorbent material, comprising the following steps:
a) loading an adsorbent material selected from the group consisting of activated carbon, activated alumina, activated TiO₂, mineral clay, zeolite, an ion exchanger, and mixtures thereof, with at least one transition metal oxide nanocatalyst selected from the group consisting of Fe₂O₃, FeOOH, FeFe₂O₃, MnFe₂O₃, CoFe₂O₃, CuFe₂O₃, TiO₂, or mixtures thereof; b) adding to polluted water at least one oxidant selected from the group consisting of oxygen, ozone, hydrogen peroxide, hydroxyl radicals, inorganic ions radicals, oxone, and mixtures thereof; and
c) mixing and/or passing the polluted water of b) containing the oxidant through said loaded adsorbent material of a), to yield purified water, purified adsorbent material and environmentally compatible reaction products.

18. The method according to claim 1, wherein said environmentally compatible reaction products comprise CO₂, H₂O and mineral acids.

19. The method according to claim 3, wherein said environmentally compatible reaction products comprise CO₂, H₂O and mineral acids.

20. (canceled)

21. (canceled)

22. The method according to claim 1 4, wherein the fluid is obtained from contaminated sludge or other solid waste mixed with or adsorbed by soil, by extracting the sludge, soil waste, or soil with an organic solvent or with water containing one or more detergents to produce a fluid containing the hazardous organic materials.

23. A method of regeneration of spent adsorbent material containing adsorbed contaminants selected from organic compounds, organisms, toxic substances, hazardous substances, ammonia, or mixtures thereof, by mixing the spent adsorbent material with a solution comprising at least one oxide of transition metal nano-catalyst and at least one oxidant, to yield an adsorbent material substantially free from said adsorbed contaminants.

24. The method according to claim 23, wherein said adsorbent material is selected from the group consisting of activated carbon, activated alumina, activated titanium dioxide, mineral clay, zeolite, ion exchangers, and mixtures thereof.

25. The method according to claim 23, wherein said at least one oxide of transition metal is an iron oxide, TiO₂, or a mixture thereof, said iron oxide is selected from the group consisting of Fe₂O₃, FeOOH, FeFe₂O₃, MnFe₂O₃, CoFe₂O₃, CuFe₂O₃, and a mixture thereof, and said oxidant is selected from the group consisting of oxygen, ozone, hydrogen peroxide, hydroxyl radicals, inorganic ions radicals, oxone, and mixtures thereof.

26. (canceled)

27. (canceled)

28. The method according to claim 23, wherein the adsorbent material is virgin or regenerated activated carbon, the at least one transition metal oxide nanocatalyst is an iron (III) oxide, and the at least one oxidant is hydrogen peroxide.

29. The method according to claim 4, wherein said environmentally compatible reaction products comprise CO₂, H₂O and mineral acids.

30. The method according to claim 3, wherein the fluid is obtained from contaminated sludge or other solid waste mixed with or adsorbed by soil, by extracting the sludge, soil waste, or soil with an organic solvent or with water containing one or more detergents to produce a fluid containing the hazardous organic materials.

31. The method according to claim 4, wherein the fluid is obtained from contaminated sludge or other solid waste mixed with or adsorbed by soil, by extracting the sludge, soil waste, or soil with an organic solvent or with water containing one or more detergents to produce a fluid containing the hazardous organic materials.
